(19) United States
(12) Patent Application Publication
(10) Pub. No.: US 2004/0247158 A1
(43) Pub. Date: Dec. 9, 2004

(54) System and method for detecting vehicle seat occupancy

(76) Inventors: Thorten Kohler, Deuerling (DE); Ulrich Wagner, Regensburg (DE)

Correspondence Address: MORRISON & FOERSTER LLP, 1650 TYSONS BOULEVARD, SUITE 300, MCLEAN, VA, 22102, US

(21) Appl. No.: 10/492,683

(22) PCT Filed: Oct. 16, 2002
(86) PCT No.: PCT/DE02/03922

(30) Foreign Application Priority Data
Oct. 18, 2001 (DE) 101 51 417.4

(51) Int. Cl. G06K 9/00

(52) U.S. Cl. 382/104; 382/154

(57) ABSTRACT

The invention relates to a system for processing image data, comprising a first data processing device (10) for processing the image data of at least two cameras (12, 14), while generating data to be further processed, and a second data processing device (16) for further processing the data to be further processed. The functions of the first data processing device (10) are substantially based on hardware that is specifically designed for said functions, and the functions of the second data processing device (16) are substantially based on software specifically configured for said functions.

This application claims priority to International Application No. PCT/DE02/03922, which was published in the German language on May 1, 2003, which claims the benefit of priority to German Application No. 101 51 417.4 which was filed in the German language on Oct. 18, 2001.

### TECHNICAL FIELD OF THE INVENTION

The invention relates to a system and a method for processing image data, and in particular, to detecting vehicle seat occupancy.

### BACKGROUND OF THE INVENTION

Systems and methods of this type are used, in particular, in motor vehicles in connection with passenger protection systems. Here, for example, image data from two cameras arranged at a distance from one another is processed in such a manner as to obtain three-dimensional image information. On the basis of this image information, it is then possible, for example, to classify the occupancy of the seats and in particular of the front-passenger seat. The deployment behavior of an airbag can then, for example, be influenced on this basis. Further applications relate, for example, to assisting a driver in controlling a vehicle, for example via lane detection.

The processing of image data is at least in part computationally very demanding. On the other hand, it is necessary to achieve high processing speeds, since only in this way can reliable image information be generated and since numerous applications which are connected with driving safety are highly time-critical.

In order to achieve the desired high processing speeds, it has already been proposed in an earlier patent application that the image data processing be implemented in hardware. An FPGA (field programmable gate array) and/or an ASIC (application-specific integrated circuit), for example, are used for this purpose. These data processing devices can, by virtue of their digital synchronous logic design, operate extremely parallelized. In this way, it is possible to achieve processing speeds that are orders of magnitude higher while operating in part at a significantly reduced system clock speed.

Thus, while the implementation of the image data processing in hardware results in a significant improvement in the systems with regard to processing speed and the problems associated therewith, because of the hardware implementation flexibility is lost. Such flexibility is, however, for various applications and/or the adjustment of the systems to specific circumstances also an important variable with regard to the optimization of image data processing systems and the methods connected therewith.

In this regard, German patent DE 34 25 946 discloses, for example, a distance meter with a pair of optical sensor arrangements, wherein the functions of the first data processing device are substantially based on hardware that is specifically configured for said functions, and the functions of the second data processing device are substantially based on software that is specifically configured for said functions. However, in the first data processing device, values of maximum match are determined and forwarded to the second data processing device for further processing. In this context, it is not possible, for example, to eliminate, preferably flexibly, non-critical peak values of the evaluation function, which in the case of implementation in a hardware circuit would scarcely be achievable or only at great cost and would generally be uneconomic.

### SUMMARY OF THE INVENTION

The invention relates to a system and a method for processing image data, comprising a first data processing device for processing image data from at least two cameras, while generating data to be further processed, and a second data processing device for further processing the data to be further processed. The functions of the first data processing device are substantially based on hardware that is specifically designed for the functions, and the functions of the second data processing device are substantially based on software specifically configured for the functions.

The invention seeks to remove the disadvantages of the prior art, and in particular, to provide a system and a method for processing image data, the system and method offering high data-processing speeds coupled with a high degree of flexibility.

The invention builds on the generic system in that the functions of the first data processing device comprise the generating of correlation curves as data to be further processed. Additionally, the functions of the second data processing device comprise the analyzing of the correlation curves generated by the first data processing device. In this way, it is possible to realize processing steps that are demanding in terms of computing time through the specific development of hardware, while steps that are less demanding in terms of computing time but for which a high degree of flexibility is required are executed in a processor or a controller. The generating of correlation curves on the basis of the results of comparison between data from different cameras is very demanding in terms of computing time. In principle, however, the calculation of these correlation curves can be performed identically in numerous systems. The solution proffered therefore is to perform these calculations using specific hardware. In contrast to this, the further processing of correlation curves, for example the searching for extreme values in the correlation curves to provide depth information of a three-dimensional image, is not particularly demanding in terms of computing time. It is, however, especially desirable to be sufficiently flexible at this point in order to be able to adapt the system to different applications. This is achieved on the basis of the software processing.

In one embodiment according to the invention, the functions of the first data processing device comprise a preprocessing of the image data into preprocessed data and in that correlation curves are generated from the preprocessed data. Such preprocessing includes, for example, a census transformation that is demanding in terms of computing time, as a result of which the advantage of a high processing speed already comes into play in the preprocessing. The further processing of the preprocessed data into correlation curves is also demanding in terms of computing time, so this function should also be undertaken by the first processing device.

In another embodiment of the present invention, the first data processing device receives data from two cameras, which together form a stereo camera, such that the data from each camera is subdivided into multiple image areas and that the data of image areas of the first camera is compared with data of adjacent image areas of the second camera, as a result of which a correlation curve is generated for each image area of the first camera subjected to the comparison. If it is assumed for example that the first camera is a left-hand-side camera, then each image area of the preprocessed image on the left can be compared with multiple, for example 24, directly adjacent image areas of the preprocessed image on the right, i.e. the image of the second camera. Each individual comparison returns a value which characterizes the match of the corresponding image areas. For each area of the image on the left-hand side, multiple, i.e. 24 in the present example, comparison results are produced. This sequence of comparison results serves as a correlation curve or as a correlation function. Consequently, a correlation curve is produced for each image area of the left-hand image. Where the first camera is assigned as a left-hand camera and the second camera as a right-hand camera, as described in the example, the term “left-right correlation” is used.

In still another embodiment of the present invention, the first data processing device to receive data from two cameras, which together form a stereo camera, for the data of each camera to be subdivided into multiple image areas and for the data of image areas of the second camera to be compared with data of adjacent image areas of the first camera, as a result of which a correlation curve is generated for each image area of the second camera subjected to the comparison. If the first camera is again the left-hand camera and the second camera again the right-hand camera, then a “right-left-correlation” is described in the case of the method described in the present invention. This can be carried out instead of or in addition to a “left-right-correlation”. If both correlations are carried out, then the quality of a three-dimensional image can be significantly improved through a comparative analysis of both sets of correlation curves. This comparative analysis is preferably also undertaken in a flexible manner by the second data processing device, i.e. preferably by the controller.

The invention is preferably fashioned such that the analyzing by the second data processing device of the correlation curve generated by the first data processing device comprises the generating of three-dimensional images. The analysis of such a three-dimensional image or of such three-dimensional images can indicate, trigger or influence various procedures in a motor vehicle.

It is also particularly preferred that, on the basis of the analysis of the correlation curves, a classification be made of a seat occupancy in a motor vehicle. This is especially useful with regard to the deployment behavior of the front-passenger airbag.

It can also be useful that, on the basis of the analysis of the correlation curves, a driver be assisted in controlling a motor vehicle. Functions like lane detection, accident prevention, stop and go, etc. can be supported here.

The invention builds on the generic method in that the functions of the first data processing device comprise the generating of correlation curves as data to be further processed and in that the functions of the second data processing device comprise the analyzing of the correlation curves generated by the first data processing device. In this way, the characteristics and advantages of the system according to the invention are also achieved within the framework of a method. This also applies to the preferred embodiments of the method according to the invention described below.

The method is further developed in a particularly advantageous manner in that the functions of the first data processing device comprise preprocessing of the image data into preprocessed data and in that correlation curves are generated from the preprocessed data.

It is also provided in an advantageous manner that the first data processing device receives data from two cameras, which together form a stereo camera, that the data of each camera is subdivided into multiple image areas and that the data of image areas of the first camera is compared with data of adjacent image areas of the second camera, as a result of which comparison a correlation curve is generated for each image area of the first camera subjected to the comparison. In still another embodiment according to the invention, the first data processing device to receive data from two cameras which together form a stereo camera, for the data of each camera to be subdivided into multiple image areas and for the data of image areas of the second camera to be compared with data of adjacent areas image areas of the first camera, as a result of which comparison a correlation curve is generated for each image area of the second camera subjected to the comparison.

Furthermore, in another embodiment according to the invention, it is advantageously designed such that the analyzing by the second data processing device of the correlation curve generated by the first data processing device comprises the generating of three-dimensional images.

It is also preferred that on the basis of the analysis of the correlation curves a classification be made of a seat occupancy in a motor vehicle.

Furthermore, the method can be useful in that on the basis of the analysis of the correlation curves a driver is assisted in controlling a motor vehicle.

The invention is based upon the recognition that substantial advantages can be achieved by separating algorithms which are demanding in terms of computing time and algorithms which are less demanding in terms of computing time for execution using different data processing systems. In systems of the prior art, the entire image-generation algorithm was previously executed either fully in a controller or fully in an ASIC and/or FGPA. On the basis of the invention, algorithms which are demanding in terms of computing time and in respect of which no flexibility has be made available, are implemented by hardware in the ASIC and/or FPGA.

Algorithms requiring less computing time which should advantageously also be flexibly designed are executed by a controller.

### BRIEF DESCRIPTION OF THE DRAWINGS

The invention will now be explained using preferred embodiments by way of example with reference to the accompanying drawings, in which:

FIG. 1 shows a schematic block diagram of a system according to the invention.

FIG. 2 shows a flowchart for explaining a method according to the invention.

### DETAILED DESCRIPTION OF THE INVENTION

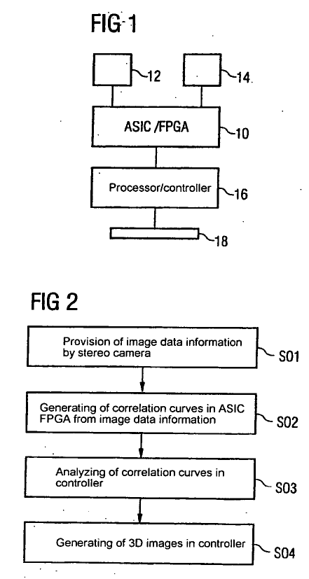

FIG. 1 shows a schematic block diagram of a system according to the invention. There are provided two cameras 12, 14 or camera devices which are connected to a first data processing device 10 for communicating data. The first data processing device 10 is connected to a second data processing device 16 for communicating further, which data processing device 16 can communicate for example with a CAN bus 18 of a motor vehicle.

The system is thus divided into two data processing devices 10, 16, the respective processing functions being assigned to the data processing devices 10, 16 in accordance with the computing effort connected with the processing. Consequently, algorithms which are demanding in terms of computing time are processed in the data processing device 10 which is capable of providing substantially higher processing speeds than the data processing device 16, while the algorithms which are less demanding in terms of computing time are executed in the data processing device 16. In particular, it is furthermore ensured that in the data processing device 10 those algorithms are executed which do not generally have to be flexibly adapted to certain applications, while in the data processing device 16 those algorithms are executed for which very many parameters may possibly have to be optimally adapted to applications. In this way, on the basis of the system according to the invention two problems are solved simultaneously. Firstly, a high processing speed is obtained since demanding algorithms are executed in the “fast” data processing device 10 which is based on a hardware implementation. In contrast to this, algorithms that are less demanding in terms of computing time are executed in the “slow” data processing device 16, although here there is a high degree of flexibility due to the software implementation.

The first data processing device 10 is particularly advantageously fashioned as an ASIC or as an FPGA. An ASIC can be optimized with regard to the calculation, demanding in terms of computing time, of correlation curves such that extremely high processing speeds can be achieved. It is not necessary in each case to design different ASICs for different applications since the flexible adaptation is subsequently undertaken by the second data processing device 16.

For comparable reasons, it is particularly advantageous that the first data processing device 10 be an FPGA. Even the reprogramming of an FPGA is costly. In that the FPGA, however, is devoted exclusively to the calculation of the correlation curves, such a reprogramming is no longer necessary if different applications are required. At the same time, a high processing speed is achieved due to implementation by an FPGA.

In this context, it is particularly advantageous that the second data processing device 16 be designed as a processor or controller.

It is therefore possible to provide the flexibility of the overall system by using for example a randomly reprogrammable controller as a second data processing device 16. The computing speed of such a controller is sufficient to analyze the correlation curves, for example to determine extreme values of the correlation curves or to compare different sets of correlation curves with one another.

In concrete terms, the image data supplied by the cameras 12, 14, which together form a stereo camera 12, 14, is firstly preprocessed by the data processing device 10, whereby, for example, census transformations that are demanding in terms of computing time are executed. Correlation of the image data of the respective cameras then follows in the data processing device 10. This can, for example, be carried out such that each image area of the image of the left-hand camera 12 is compared with multiple directly adjacent image areas of the image of the right-hand camera 14. Each individual comparison returns a value which characterizes the match of the corresponding results. Consequently, for each area of the left-hand image, multiple, for example 24, comparison results are produced. This sequence of comparison results is called a correlation curve or correlation function. A correlation curve is therefore produced for each image area of the left-hand image. The method implemented in such a way is designated a “left-right correlation”. It is also possible in an analogous manner to carry out a “right-left correlation”. This can be carried out in addition to or instead of the “left-right correlation”.

Extreme values of the correlation curves are then determined in the second data processing device 16. Where multiple sets of correlation curves are available, for example a “left-right correlation” and a “right-left correlation”, the quality of a three-dimensional image generated by the data processing device 16 can be significantly improved by comparing the sets.

FIG. 2 shows a flowchart for explaining a method according to the invention.

In S01 image data information is provided by a stereo camera.

This image data information is further processed in S02 in order to generate correlation curves in an ASIC and/or an FPGA.

The correlation curves are analyzed in S03, whereby this analysis, being not especially demanding in terms of computing time, is undertaken in the controller.

In S04 three-dimensional images are generated in the controller.

These images or information which has been taken from the images can subsequently be transferred via the vehicle's CAN bus (CAN bus 18, see FIG. 1), for example, to a central control unit of the motor vehicle.

The features of the invention disclosed in the above description, in the drawings and in the claims can be essential, both individually and in any combination, to implementation of the invention. The invention is suitable in particular for classifying a seat occupancy in a motor vehicle and/or for assisting a driver in controlling a motor vehicle.

1. A system for processing image data, comprising:
a first data processing device for processing image data from at least two cameras, while generating data to be further processed; and
a second data processing device for further processing the data to be further processed, wherein
the functions of the first data processing device are substantially based on hardware configured for the functions,
the functions of the second data processing device are substantially based on software configured for the functions,
the functions of the first data processing device comprise generating correlation curves as data to be further processed, and
the functions of the second data processing device comprise analyzing the correlation curves generated by the first data processing device.

2. The system according to claim 1, wherein
the functions of the first data processing device comprise preprocessing of image data into preprocessed data and
correlation curves are generated from the preprocessed data.

3. The system according to claim 1, wherein
the first data processing device receives data from two cameras, which form a stereo camera,
the data of each camera is subdivided into multiple image areas, and
the data of image areas of the first camera are compared with data of adjacent image areas of the second camera resulting in a correlation curve generated for each image area of the first camera subjected to the comparison.

4. The system according claim 1, wherein
the first data processing device receives data from two cameras, which form a stereo camera,
the data of each camera is subdivided into multiple image areas, and
the data of image areas of the second camera are compared with data of adjacent image areas of the first camera resulting in a correlation curve generated for each image area of the second camera subjected to the comparison.

5. The system according to claim 1, wherein the analyzing by the second data processing device of the correlation curve generated by the first data processing device comprises the generating of three-dimensional images.

6. The system according to claim 1, wherein based on the analysis of the correlation curves, a classification is made of a seat occupancy in a motor vehicle.

7. The system according to claim 1, wherein based on the analysis of the correlation curves, a driver is assisted in controlling a motor vehicle.

8. A method for processing image data, comprising:
processing image data, with a first data processing device, from at least two cameras, whereby data to be further processed is generated; and
processing the data to be further processed with a second data processing device, wherein
the functions of the first data processing device are substantially based on hardware configured for the functions,
the functions of the second data processing devices are substantially based on software configured for the functions,
the functions of the first data processing device comprise generating correlation curves as data to be further processed, and
the functions of the second data processing device comprise analyzing correlation curves generated by the first data processing device.

9. The method according to claim 8, wherein
the functions of the first data processing device comprise a preprocessing of image data into preprocessed data, and
correlation curves are generated from the preprocessed data.

10. The method according to claim 8, wherein
the first data processing device receives data from two cameras, which together form a stereo camera,
the data of each camera is divided into multiple image areas, and
the data of image areas of the first cameras are compared with data of adjacent image areas of the second camera, resulting in a correlation curve generated for each image area of the first camera subjected to the comparison.

11. The method according to claim 8, wherein
the first data processing device receives data from two cameras, which form a stereo camera,
the data of each camera is subdivided into multiple image areas, and
the data of image areas of the second camera is compared with data of adjacent image areas of the first camera, resulting in a correlation curve generated for each image area of the second camera subjected to the comparison.

12. The method according to claim 8, wherein
the analyzing by the second data processing device of the correlation curve generated by the first data processing device comprises the generating of three-dimensional images.

13. The method according to claim 8, wherein based on the analysis of the correlation curve a classification is made of a seat occupancy in a motor vehicle.

14. The method according to claim 9, wherein based on the analysis of the correlation curves a driver is assisted in controlling a motor vehicle.
